(19) United States
(12) Patent Application Publication
(10) Pub. No.: US 2012/0318623 A1
(43) Pub. Date: Dec. 20, 2012

(54) DEVICE FOR DAMPING COMPRESSIVE FORCES

(75) Inventor: Klaus Mombour, Moers (DE)

(73) Assignee: Voith Patent GmbH, Heidenheim (DE)

(21) Appl. No.: 13/495,094

(22) Filed: Jun. 13, 2012

(30) Foreign Application Priority Data
Jun. 14, 2011 (EP) 11 169 783.5

(51) Int. Cl. F16F 9/50; F16F 9/516; F16F 9/34; F16F 9/06

(52) U.S. Cl. 188/269; 188/283; 188/282.7

(57) ABSTRACT

The invention relates to a device for damping compressive forces designed to be reversible also upon dynamic impact load. With the objective of achieving the lowest possible construction volume while simultaneously retaining favorable damping properties both upon static as well as dynamic compression, the device comprises a cylinder having a hydraulic chamber, a hollow piston, a valve arrangement and a separating piston, wherein the valve arrangement divides the hydraulic chamber into a front hydraulic chamber region and a rear hydraulic chamber region and the separating piston separates a head space from the front hydraulic chamber region. The valve arrangement comprises an eccentric hydraulic compartment connected to a transfer-flow area which is sealed by an eccentrically arranged multiplier valve.

### BACKGROUND OF THE INVENTION

The present invention relates to a device for damping compressive forces in the form of a shock absorber designed to be reversible also upon dynamic impact load.

Printed publication DE 195 23 469 A1 relates to a hydraulic capsule, particular for railway buffers, consisting of the combination of a hydraulic damper and a gas spring. A multiplier valve which increases the gas spring's resistance upon the quasi-static loading of the hydraulic capsule is disposed between the hydraulic damper and the gas spring. A pressure relief valve is connected in parallel to the multiplier valve which remains closed upon quasi-static loading and opens upon dynamic loading so as to override the function of the multiplier valve.

Printed publication EP 2 065 287 A2 relates to a suspension-damper unit for an impact reduction element to dampen pressure surges, particularly for rail vehicles, wherein the suspension-damper unit comprises the following: a cylinder, a piston displaceably guided along the longitudinal axis, a variable-volume hydraulic high-pressure working chamber limited by the cylinder and the piston, a variable-volume low-pressure overflow chamber connected to the high-pressure working chamber by means of a piston position-dependent throttle, and a return spring. At least one counter balance valve is thereby provided and fluidically connected in series with piston position-dependent throttle such that all the hydraulic fluid flowing through the piston position-dependent throttle from the high-pressure working chamber to the low-pressure overflow chamber also flows through at least one counter balance valve. The at least one counter balance valve thereby opens only upon reaching, respectively exceeding, a predefined minimum pressure difference between its high pressure side associated with the high-pressure working chamber and its low pressure side associated with the low-pressure overflow chamber.

Employing shock absorbers between the individual car bodies of a multi-member vehicle, for example in the form of so-called buffers, is known in the field of railway vehicle technology. Such components are constructed so as to absorb energy in the event of a collision with a stationary or moving obstacle, for example another car body, and thereby prevent damage to the vehicle or its cargo. These types of buffers are primarily used on railway vehicles, whereby one or two structural parts serving to absorb the external horizontal compressive forces acting on the railway vehicle in its longitudinal direction are usually mounted to the front ends.

Two types of buffers are hereby primarily used on railway vehicles. So-called central buffers constitute a shock absorber disposed on the longitudinal axis of the vehicle such that there is only one buffer centered on the buffer beam at each end of the vehicle. So-called side buffers are further known in which two respective buffers are provided on the end of the railway vehicle.

Equipping individual car bodies with side buffers (“UIC buffers”) is known in rail vehicle technology, for example in the case of a multi-member railway vehicle, when the car bodies are not connected together by means of a bogie and thus the distance between two coupled car bodies can vary during travel. Such side buffers serve for example to absorb and dampen the impacts occurring upon braking during normal travel.

Utilizing so-called gas-hydraulic dampers consisting of a combination of a gas pressure spring and a hydraulic transfer-flow system is known in order to achieve both a good compression response of the buffer upon quasi-static compression as well upon dynamic load. Upon static or quasi-static compression of such a conventional gas-hydraulic buffer, fill gas, normally nitrogen, is compressed within the gas pressure spring component of the buffer and thus produces a counter-force on the buffer head. Upon the abating of the external force acting on the buffer, the gas spring effects the so-called return stroke by means of the subsequent expansion of the fill gas; i.e. the rebounding back of the buffer.

Upon the dynamic loading of such a conventional gas-hydraulic damper, hydraulic oil or other hydraulic fluid flowing through a throttle gap additionally ensures that the drop in pressure over the throttle gap occurring during the flowing process generates an opposing hydraulic force that follows a dynamic force curve which acts against the momentum effecting the compression.

It is desirable with such gas-hydraulic damper combinations to only allow the hydraulic fluid to discharge over the throttle gap against the pressure of the gas spring once a certain minimum force has been exceeded during compression in order not to reduce the contribution the gas spring makes to the total cushioning of above all static loads.

It is hence known to provide so-called multiplier valves which are arranged such that the pressure prevailing in the head space of the gas pressure spring directly or indirectly acts on the larger effective area of the multiplier valve (“multiplier area”) and such a multiplier valve is pressed into its valve seat by said directly or indirectly acting gas pressure. The smaller effective area of the multiplier valve; i.e. on the opposing side, is then in operative connection with the hydraulic part of the conventional gas-hydraulic damper. Not until the pressure in the hydraulic fluid multiplies, for instance to five times the gas pressure—for example in consequence of a quasi-static compression of the buffer upon an impact—is this high pressure able to act on the smaller effective area of the multiplier valve so as to displace it far enough out of its seat to expose a passage gap through which the hydraulic fluid can flow, for example into a hydraulic reservoir. Utilizing such a multiplier valve in particular also achieves that the gas pressure in the head space of the gas pressure spring can be kept relatively low when a buffer is fully extended. This make it possible to maintain a favorable static response curve for the gas pressure spring component of the gas-hydraulic damper.

The combination of a hydraulic throttling mechanism, for example in the form of a throttle pin with such a multiplier valve, with the known buffer arrangements leads, however, to a relatively voluminous configuration since the throttle pin is disposed on a center axis of the buffer cylinder and the multiplier valve completely encloses the transfer-flow area behind the throttle pin. In order to have a correspondingly large effective area on the gas pressure spring side, the volume of the multiplier valve thus needs to be clearly larger than the transfer-flow area through which the hydraulic fluid from the rear hydraulic chamber flows over the throttle gap formed by the throttle pin.

Consequently, the conventional device needs to provide for a multiplier valve which, due to its large constructional volume, requires a great deal of material and is additionally complicated to construct.

### SUMMARY OF THE INVENTION

It is accordingly an object of the present invention to specify a device which enables the combination of a throttling mechanism, for example in the form of a throttle pin, and a multiplier valve, wherein the multiplier valve is of small, economical and simple construction.

This object is solved according to the invention by a device for damping compressive forces which has a valve arrangement comprising a transfer-flow area configured in an end region of a hollow piston, whereby a multiplier valve is provided which seals an eccentrically arranged hydraulic compartment connected to the transfer-flow area by means of at least one passage with its rear effective area (inlet area), whereby the multiplier valve is in turn eccentrically arranged in relation to the center axis of the hollow piston.

The hollow piston of the inventive device is thereby telescopically displaceable along its center axis relative to a receiving cylinder, whereby the valve arrangement at the end region of the hollow piston serves to divide a hydraulic chamber formed in the receiving cylinder into a rear hydraulic chamber region and a front hydraulic chamber region. A head space is further configured in the hollow piston on its opposing end to the valve arrangement, separated from the front hydraulic chamber region by means of a separating piston. The separating piston is likewise displaceably arranged along the center axis.

Upon compression; i.e. upon the hollow piston pushing into the cylinder, e.g. as a result of an impact, pressure is applied to the hydraulic fluid in the rear hydraulic chamber which in consequence thereof then flows into the transfer-flow area of the valve arrangement and from there through the at least one passage in the eccentric hydraulic compartment to the inlet side of the multiplier valve. The same pressure then prevails in this case in the rear hydraulic chamber, the transfer-flow area and the eccentric hydraulic compartment.

In the front hydraulic chamber region; i.e. in the area between the separating piston and the outlet area of the multiplier valve likewise filled with hydraulic fluid, the same pressure prevails as within the head space on the other side of the separating piston in consequence of the free movement of the separating piston. When the pressure in the eccentric hydraulic compartment at the inlet side of the multiplier valve multiplied by the layout factor of the multiplier valve exceeds the pressure in the front hydraulic chamber; i.e. if the pressure prevailing in the eccentric hydraulic compartment is great enough to push the multiplier valve out of its valve seat against the pressure prevailing in the front hydraulic compartment, a passage gap will be formed on the multiplier valve through which hydraulic fluid can flow into the front hydraulic chamber from the eccentric hydraulic compartment; i.e. thus also from the rear hydraulic chamber. In consequence of this space-occupying process, the separating piston moves further into the head space and compresses the gas contained therein.

By providing the eccentric hydraulic compartment additionally to the transfer-flow area, it is thus possible to eccentrically arrange the multiplier valve such that it itself does not need to enclose the transfer-flow area. This achieves a substantial reduction in the multiplier valve's volume, which also considerably simplifies its construction. In addition to the simple and economical design, the off-center arrangement of the multiplier valve in the valve arrangement yields the further advantage of being able to provide for a throttle pin on the device for damping compressive forces without the use of the multiplier valve leading to a voluminous construction. The resultant consequence of the very little constructional space required is that the overall length of the damping device does not need to be enlarged.

Advantageous further developments of the invention are specified in the dependent claims.

For example, it is provided to affix a throttle pin to the cylinder at its center axis such that the throttle pin extends into the transfer-flow area of the valve arrangement. A throttle gap, usually an annular throttle gap, is therefore formed in the connecting area between the rear hydraulic chamber and the transfer-flow area. Hydraulic fluid forced out of the rear hydraulic chamber thus flows through this throttle gap formed between the throttle pin and the transfer-flow area, whereby the resulting drop in pressure is primarily contingent upon the cross section of the gap. If the hollow piston penetrates further into the cylinder, the valve arrangement formed on the end region of the hollow piston hence also displaces further into the cylinder, whereby the throttle pin penetrates deeper into the transfer-flow area of the valve arrangement. Due to a specially adapted design to the throttle pin, the cross section of the throttle gap reduces upon the penetration of the throttle pin; i.e. the gap cross section of the throttle gap becomes smaller the deeper the throttle pin penetrates into the transfer-flow area of the valve arrangement.

These constructional measures take into account that during a shock absorbing process by the damper due to the energy absorption, the relative velocity of colliding vehicles decreases over the temporal course of the impact. During the course of such an impact, the speed of pressing down; i.e. the damper compression speed, thus also reduces due to the vehicle masses decelerating. Apart from the dependency of further parameters, the hydraulic forces thereby occurring can be specified as a function of the throttle gap cross section and the speed of pressing down; i.e. the damper compression speed. Because the design of the throttle pin is such as to reduce the throttle gap cross section as a function of its depth of penetration into the transfer-flow area of the valve arrangement, the ensuing hydraulic force can be kept as constant as possible due to the decreasing speed with which the throttle pin penetrates into the transfer-flow area during the compression process. At the same time, being combined with the eccentrically arranged multiplier valve ensures that a simple arrangement and low overall structural volume will yield an advantageous static response curve for the damper mechanism as it were, also in this case of combining with a throttle pin.

It is further provided for the valve arrangement to further comprise an overload valve, whereby the over-load valve is connected to the rear hydraulic chamber by means of at least one overload passage and in the open state enables a transfer of the hydraulic fluid from the rear hydraulic chamber region into the front hydraulic chamber region bypassing the regular fluid path through the transfer-flow area and the multiplier valve. Such an overload valve (also called pressure relief valve) is thereby usually arranged in the area of the valve arrangement adjoining the front hydraulic chamber and held in its valve seat by means of a preload force. Under normal damper load, the overload valve thus seals the at least one overload passage by its inlet area being in direct operative connection with the rear hydraulic chamber region.

The preload force which holds the overload valve in its valve seat is usually several times higher than the force resulting due to the pressure differential between the eccentric hydraulic compartment and the front valve chamber on the rear effective area (valve inlet) of the multiplier valve during normal operating condition; i.e. during normal driving or shunting operation of the car body. An overload, which entails an extreme increase in pressure within the rear hydraulic chamber and thus also in the overload passage, can ensue for example upon an accidental collision of the railway vehicle with an obstacle. In this case, the overload valve is pushed out of its valve seat against the preload force and enables a direct transfer of the hydraulic fluid from the rear hydraulic chamber into the front hydraulic chamber. The eccentric arrangement of the multiplier valve allows the achieving of, for example by means of a plurality of transfer passages, a substantially larger effective flow cross section to this system of transfer passages and transfer valve with simultaneously higher preload force to the overload valve than the effective flow cross section through the throttle gap, the eccentric hydraulic chamber and the multiplier valve. This thus particularly advantageously yields a behavior of the damper independent of the actuating speed upon overload, which prevents plastic deformation of the device for damping compressive forces in such a case of overload and thus hydraulic fluid from spilling out into the environment.

It is possible to employ a spring, preferably an annular spring, to apply the preload force which holds the overload valve in its seat. This solution has the advantage of being able to use very simple and effective constructional means to define the preload force, also called actuating force, necessary to actuate the overload valve.

It is particularly advantageously provided to define the actuating force necessary to open the overload valve in a range of between 700 and 900 kN, preferably 800 kN, in order to meet the usual standards.

It is particularly advantageous for the effective flow cross section of the rear hydraulic chamber region through the throttle gap and the passage gap of the open multiplier valve to be smaller than the effective flow cross section of the rear hydraulic chamber region through the overload pressure gap of the open overload valve. This has the advantage of creating an effective bypass path for the hydraulic fluid bypassing the conventional flow path through the throttle gap and past the multiplier valve when the overload valve is actuated.

When dimensioning the actuating force for the overload valve, it is additionally provided for the minimum force necessary to open the multiplier valve as a result of the pressure ratio between the pressure in the eccentric hydraulic compartment and the pressure in the rear hydraulic chamber region to be lower than the minimum actuating force necessary to open the overload valve, for example the spring actuating force.

It is further provided for the valve arrangement to moreover comprise a non-return valve, in particular a ball non-return valve, whereby the non-return valve is arranged such that it then enables a return flow of the hydraulic fluid from the front hydraulic chamber region into the transfer-flow area, respectively from the front hydraulic chamber region into the rear hydraulic chamber region precisely when the pressure in the front hydraulic chamber region is greater than the pressure in the transfer-flow area, respectively the pressure in the rear hydraulic chamber region. Such a solution with non-return valve enables regulating the rebounding of the damper, the so-called return stroke, such that said return stroke can occur quickly, without yielding a bypass possibility through the return stroke channel, thus the possibility for the hydraulic fluid from the transfer-flow area to bypass the multiplier valve into the front hydraulic chamber in the case of load; i.e. upon compression.

It can furthermore be provided to select the area ratio between the front effective area, thus the outlet area of the multiplier valve, and the rear effective area, thus the inlet effective area of the multiplier valve, such that to open the multiplier valve, the pressure in the eccentric annulus is many times more than the pressure prevailing in the front hydraulic chamber region. It is hereby of particular advantage to specify the multiplication factor for the multiplier valve in a range of between two and eight, e.g. five, meaning that the pressure prevailing in the eccentric annulus is a value of that within the front hydraulic chamber region multiplied by the given multiplication factor in order to displace the multiplier valve from its valve seat into its open position. In the selected example; i.e. when the multiplication factor is defined at five, at least five times the pressure of that in the front hydraulic chamber region needs to prevail in the eccentric annulus to open the multiplier valve. Due to the free movement of the separating piston within the hollow piston, the same pressure prevails in the front hydraulic chamber region as in the head space. Consequently, a pressure corresponding to the pressure in the rear hydraulic chamber multiplied by the reciprocal of the multiplication factor is attained within the gas spring, thus in the head space, in order to keep the multiplier valve in its valve seat; i.e. in the closed position, and thus prevent a premature transfer flow of the hydraulic fluid out of the transfer-flow area into the front hydraulic chamber. In the selected example of a multiplication factor of five, this thus means than a fifth of the pressure prevailing in the rear hydraulic chamber will suffice within the gas spring to keep the multiplier valve closed. The fill pressure of the head space can thereby be calculated to be considerably less than if no multiplier valve were provided.

With respect to the head space, it is provided for same to be filled with a gas under positive pressure. Said positive pressure gas can in particular be nitrogen. The selection of the gas and its thereby associated thermodynamic properties as well as the selection of the positive pressure can thus advantageously impact the static response curve of the inventive device for damping compressive forces.

It is moreover provided for the hollow piston to be provided with at least one hollow piston sealing element, wherein said hollow piston sealing element is configured such that it ensures a sealing of the interior space against the exterior space during the displacing of the hollow piston within the cylinder.

It can further be provided to also equip the separating piston with at least one separating piston sealing element which, in addition to its sealing properties, quasi ensures a leveling off of hydraulic fluid, e.g. by means of scrapers, when the separating piston is displaced within the hollow piston. The purity of the fill gas within the head space is hereby affected as minimally as possible, which contributes to increasing the longevity of the inventive device and allows the prolonging of maintenance intervals.

When coupled track-guided vehicles are in overrun operation, it may be necessary to limit the operational compression of the inventive device for damping compressive forces by means of a high preload on the gas spring component in order to limit jolts on a pushed convoy of coupled track-guided vehicles upon a sudden braking in the direction of the train's loaded coupling devices during deceleration so as to prevent damage to the coupling devices such as for example coupler hooks or the like breaking off.

Because of the high preload of the gas spring component of the device for damping compressive forces and the desired low operational spring travel thereby effected during overrun operation, there is at the same time the disadvantage that in the event of any accidental impact which might occur, the dynamic forces may no longer be able to be limited to the necessary extent due to this high preload.

To this end, it can be provided for the multiplier valve to comprise a multiplier valve damper. For its part, said multiplier valve damper comprises a damping piston, a damping annulus as well as a damper overflow mechanism. The damping piston of the multiplier valve damper is connected to the front effective area of the multiplier valve and then allows, when the multiplier valve is opened to its maximum, a largely undamped transfer of hydraulic fluid into the damping annulus. Upon a stronger compression of the damper, the gas pressure within the gas spring then increases which has the direct effect of increasing the force acting on the front effective area of the multiplier valve and pressing the multiplier valve out of its open position toward its closed position. The damper overflow mechanism, which can for example be configured as a specially grooved piston ring, is then designed such that in this event, of the multiplier valve being moved out of its maximum open position toward its closed position, only a damped transfer of hydraulic fluid is allowed from the damping annulus back into the front hydraulic chamber region. During this transfer process, the movement of the multiplier valve from its maximum open position toward its closed position is damped so that such a damped multiplier valve stays at least partly open over a longer period of time than a multiplier valve without a multiplier valve damper.

This thereby achieves the advantage that in the event of a dynamic actuating of the device for damping compressive forces, the dynamic forces can be better limited to the necessary extent upon impact. In the event of a quasi-static actuating of the device for damping compressive forces, the leakage flow of hydraulic fluid made possible by the damper overflow mechanism is calculated such that in this case, the multiplier effect of the multiplier valve can be more or less fully maintained such that upon such a quasi-static actuating, the full multiplier effect is largely maintained.

The following will reference the drawings in describing two preferred embodiments of the inventive device for damping compressive forces in greater detail.

### BRIEF DESCRIPTION OF THE DRAWINGS

In the drawings:

FIG. 1 is a sectional view of a first embodiment of the inventive device;

FIG. 2 is a detail of the valve arrangement of FIG. 1;

FIG. 3 is a sectional view of a second embodiment of the inventive device;

FIG. 4 is a detail of the valve arrangement of FIG. 3; and

FIG. 5 is a valve arrangement similar to the valve arrangement from FIG. 2, wherein use is made of a multiplier valve having a multiplier valve damper.

### DETAILED DESCRIPTION OF AN ILLUSTRATIVE EMBODIMENT

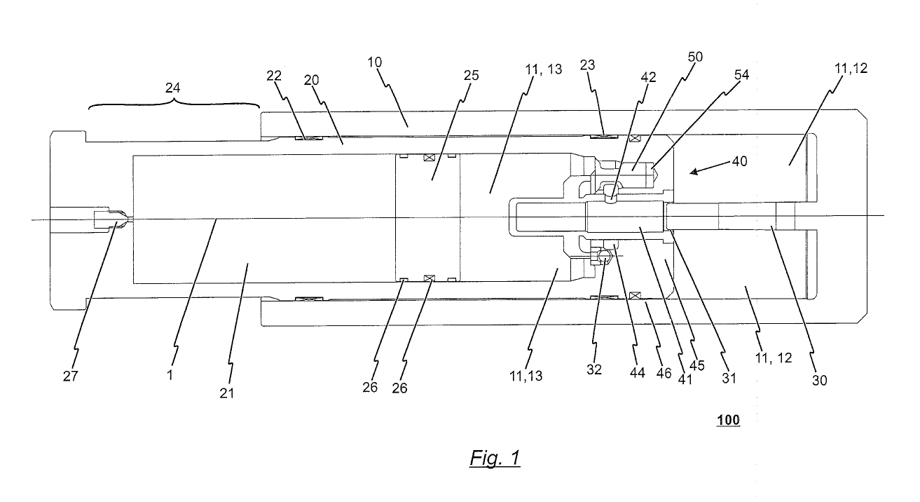

FIG. 1 shows a sectional view of a first embodiment of a device for damping compressive forces which essentially consists of a cylinder 10 and a telescopically displaceable hollow piston 20 arranged therein along a center axis 1. A valve arrangement 40 is disposed in one end region of the hollow piston which divides a hydraulic chamber 11 configured within the cylinder 10 into a rear hydraulic chamber region 12 and a front hydraulic chamber region 13. The hydraulic chamber 11 thus extends at least partly into the hollow piston 20; in other words, the front hydraulic chamber region 13 is formed within the hollow piston 20.

A separating piston 25 divides the front hydraulic chamber region 13 from a head space 21 formed within the hollow piston 20, wherein the head space 21 can be filled with a pressurized fill gas through a fill valve 27. The separating piston 25 comprises a separating piston sealing element 26 and is arranged so as to be movable along the center axis 1. An increase in volume in the front hydraulic chamber region 13, for example due to hydraulic fluid flowing into the front hydraulic chamber region 13 from the rear hydraulic chamber region 12, thus effects a displacing of the separating piston 25 into the head space 21, whereby the fill gas in the head space 21 is simultaneously compressed.

Upon a displacement of the hollow piston 20 within cylinder 10, first hollow piston sealing element 22 and second hollow piston sealing element 23 prevent hydraulic fluid from escaping from the hydraulic chamber 11 past the gap between cylinder 10 and hollow piston 20 into the external area surrounding the device 100. In particular, not-shown scrapers on the first hollow piston sealing element 22 and/or the second hollow piston sealing element 23 for example ensure that essentially no hydraulic fluid moistens the upper surface of the external area 24 of the hollow piston not currently pushed inside the cylinder.

A throttle pin 30 is configured in the rear hydraulic chamber region of the hydraulic chamber and fixed at the center axis 1 of the cylinder. In the state of the device 100 depicted in FIG. 1, the throttle pin 30 partly projects into a transfer-flow area 41 of the valve arrangement 40 such that a throttle gap 31 is formed between the throttle pin 30 and the transfer-flow area 41. Hydraulic fluid which flows from the rear hydraulic chamber region 12 into the transfer-flow area 41 is throttled by the drop in pressure at the throttle gap 31 restricted by the passage during the transfer flow. The housing 45 of the valve arrangement 40 is connected to the end region of the hollow piston 20. Upon a compressing of the inventive device 100, the hollow piston 20 is pushed longitudinally along depicted center axis 1 into the cylinder 10 due to the effect of external forces. Accordingly, the valve arrangement 40 fixed to hollow piston 20 moves further into cylinder 10; i.e. the rear hydraulic chamber region 12. A positive pressure thus develops in the rear hydraulic chamber region 12 and at low actuating speeds, thus upon quasi-static compression, the same positive pressure is established in the transfer-flow area 41 of the valve arrangement. An eccentrically arranged hydraulic compartment 43 is connected to the transfer-flow area 41 of the valve arrangement 40 by means of at least one passage 42 of said transfer-flow area such that also in this eccentric hydraulic compartment 43 in this quasi-static case, the same positive pressure is given as in the rear hydraulic chamber region 12 of the hydraulic chamber 11. This eccentric hydraulic compartment 43 is sealed via a multiplier valve 50 by its inlet side. The pressure prevailing within the front hydraulic chamber region 13 of hydraulic chamber 11 acts on the outlet side of the multiplier valve 50.

Upon sufficiently great enough pressure; i.e. upon a correspondingly sufficient pressure ratio between the pressure in the eccentric hydraulic compartment 43 and the pressure in the front hydraulic chamber region 13, the multiplier valve opens and allows a transfer-flow of hydraulic fluid from the transfer-flow area 41 through passage 42 and the eccentric hydraulic compartment 43 into the front hydraulic chamber region 13.

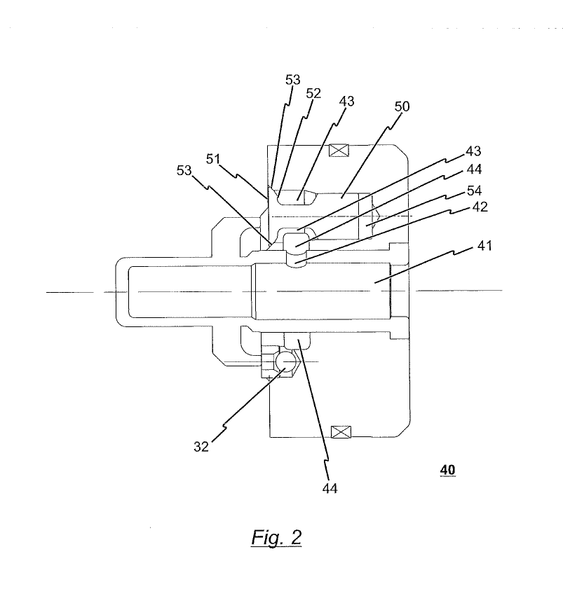

The following will make reference to the FIG. 2 detail view of the valve arrangement 40 from FIG. 1 in describing the operation of the transfer flow in detail.

Upon an inflow of hydraulic fluid through passage 42 into eccentric hydraulic compartment 43, the pressure in eccentric hydraulic compartment 43 acts on the rear effective area 52; i.e. the inlet area of the multiplier valve. If this pressure acting on the rear effective area 52 is greater than the pressure acting on the front effective area 51 of the multiplier valve multiplied by the target multiplication factor of said multiplier valve 50, the multiplier valve 50 is then pressed out of its seat and exposes passage gap 53. Among other approaches, the multiplier valve can be reset by a relatively lower pressure prevailing in the rear valve chamber 54 of the multiplier valve 50, namely the pressure corresponding to the ambient pressure during construction while a much higher pressure acts on the gas spring during the multiplier valve's closing procedure.

When at least part of the passage gap 53 is exposed when multiplier valve 50 opens upon hydraulic fluid transfer, this leads to a further drop in pressure over said passage gap 53 additionally to the drop in pressure in throttle gap 31. Particularly in the case of a quasi-static actuating of the device 100, this results in an effective static force-deflection response curve for inventive device 100.

To allow a reverse flow of the hydraulic fluid from the front hydraulic chamber region 13 to the rear hydraulic chamber region 12 upon a return stroke of the hollow piston 20 without an additional undesired transfer-flow passage between the transfer-flow area 41 and the front hydraulic chamber region 12 forming upon compressive load, a non-return valve 32 in the form of a ball valve is provided which allows a reverse flow path for the hydraulic fluid from the front hydraulic chamber region 13 to the rear hydraulic chamber region 12 and at the same time closes the transfer-flow passage additionally formed upon compressive load.

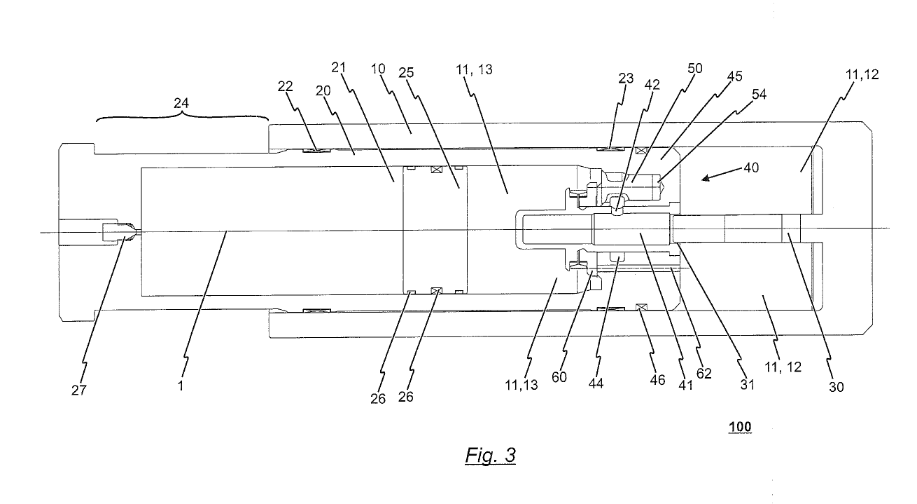

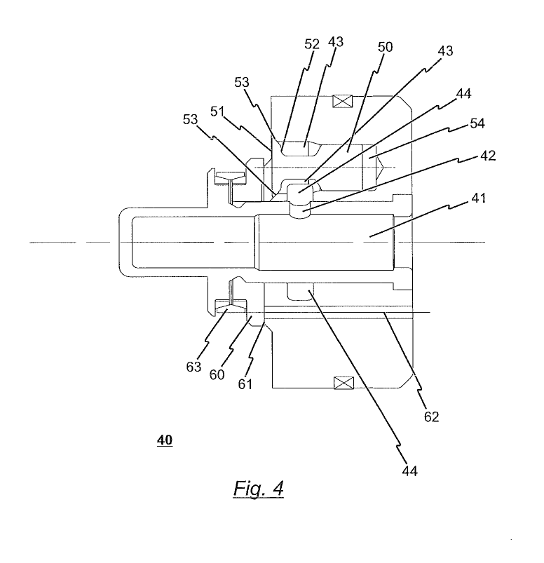

FIG. 3 shows a device 100 for damping compressive forces similar to device 100 in FIG. 1, whereby in the detail view of the valve arrangement 40 according to FIG. 4 it can be recognized that the valve arrangement 40 additionally comprises an overload valve 60 loaded by means of a spring 63. The overload valve 60 itself can be centered by means of the eccentric arrangement to the multiplier valve 50; i.e. disposed about center axis 1. The actuating surface of the overload valve 60 is connected to the rear hydraulic chamber region 12 by means of an overload passage gap 61; i.e. the same pressure prevails in overload passage 62 as in the rear hydraulic chamber region 12. The overload passage 62 can be formed by a drill hole; a plurality of overload passages 62 can be equally provided in order to obtain the largest effective flow cross section possible upon overload. Spring 63 is in particular configured as an annular spring and exhibits a high preload force, for example 20 kN. Due to the cross-sectional aspect ratios, such a spring preload of e.g. 20 kN results in a higher actuating force for the overload valve, for example 800 kN. Thereby the face of the valve on which the pressure of the at least one overload passage 62 acts in the opening direction can be relatively large, thereby enabling a large volume flow in the open position of overload valve 60.

The overload valve 60 being actuated upon overload, i.e. upon high pressure in the rear hydraulic chamber region 12, bypasses any throttling points where a drop in pressure of the flowing hydraulic fluid would be possible, and allows the hydraulic fluid to directly flow out of the rear hydraulic chamber region 12 into the front hydraulic chamber region 13 (“bypass solution”). Since only the preload force of the spring 63 of the overload valve 60 is decisive for the response pressure, the actuating hydraulic pressure for overload valve 60 respectively, and no throttling point occurs, this overload function is largely independent of the actuating speed of the device 100.

Due to the transfer flow into the front hydraulic chamber region 13 already provided as a hydraulic reservoir, only the separating piston 25 thus quickly and vigorously moves in the direction of the head space 21 due to the compressing of the gas in the head space 21 upon overload. A bursting of the inventive device 100 for damping compressive forces which would result in hydraulic fluid being discharged can thus be effectively prevented along with simultaneous retaining of a compact construction and simultaneously good static and dynamic response of device 100.

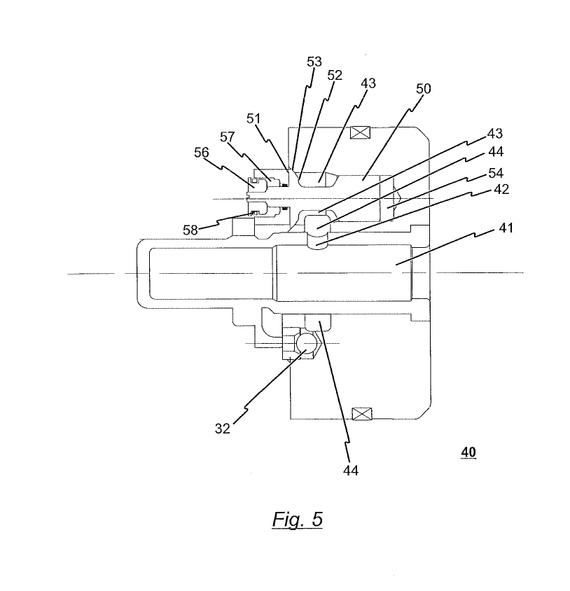

FIG. 5 shows a valve arrangement similar to the valve arrangement of FIG. 2, whereby here, however, use is made of a multiplier valve having a multiplier valve damper. The multiplier valve damper comprises a damping piston as well as a damper overflow mechanism, for instance in the form of a specially grooved piston ring, wherein a damping annulus is formed due to the special configuration of the damping piston. The damping annulus is formed between the front effective area and the damping piston. In a case in which the multiplier valve is in its maximum open position, the hydraulic fluid can flow out of the front hydraulic chamber region of the hydraulic chamber into said damping annulus via the damper overflow mechanism. As the pressure rises on the front effective area of the multiplier valve, same is moved from its maximum open position toward its closed position; i.e. moved into its valve seat. In this case, the damper overflow mechanism then abuts the arrester of the damping piston and seals off any possibility of transfer of the hydraulic fluid between the front hydraulic chamber region and the damping annulus up to a specifically provided and specifically calculated leakage flow volume. Due to this leakage flow volume from the damping annulus toward the front hydraulic chamber region while the multiplier valve is moved out of its maximum open position toward its closed position, the multiplier valve is kept longer in an open position by a period of few milliseconds upon a dynamic impact to the device for damping compressive forces. The dynamic forces in the event of a dynamic impact can hereby be better limited to the necessary extent.

In the case of a quasi-static compression of the device for damping compressive forces, for example in overrun operation of coupled track-guided vehicles, this leakage flow is calculated so as not to override the multiplier effect of the multiplier valve in this case.

The invention is not limited to the embodiments described with reference to the accompanying drawings. Rather, applicable modifications are in fact conceivable.

### List of Reference Numerals

1 center axis
10 cylinder, particularly circular cylinder
11 hydraulic chamber
12 rear hydraulic chamber region of hydraulic chamber
13 front hydraulic chamber region of hydraulic chamber
20 hollow piston
21 head space
22 first hollow piston sealing element
23 second hollow piston sealing element
24 outer area of hollow piston not pushed in
25 separating piston
26 separating piston sealing element
27 fill valve
30 throttle pin
31 throttle gap
32 non-return valve
40 valve arrangement
41 transfer-flow area of valve arrangement
42 transfer-flow area passage
43 eccentric hydraulic compartment
44 annulus
45 valve arrangement housing
46 valve arrangement sealing element
50 multiplier valve
51 front effective area of multiplier valve
52 rear effective area of multiplier valve
53 multiplier valve passage gap
54 rear valve chamber of multiplier valve
55 multiplier valve damper
56 damping piston
57 damping annulus
58 damper overflow mechanism
60 overload valve
61 overload passage gap
62 overload passage
63 overload valve spring
100 device for damping compressive forces

What is claimed is:

1. A device for damping compressive forces, wherein the device comprises the following:
a cylinder, in particular a circular cylinder, in which a hydraulic chamber is formed;
a hollow piston telescopically displaceable along a center axis relative to the cylinder;
a valve arrangement configured at an end region of the hollow piston to divide the hydraulic chamber into a rear hydraulic chamber region and a front hydraulic chamber region; and
a separating piston disposed in the hollow piston to be movable along the center axis which separates a head space configured in the hollow piston from the front hydraulic chamber region,
wherein the valve arrangement comprises a transfer-flow area connected to the rear hydraulic chamber region and an eccentric hydraulic compartment connected to the transfer-flow area by means of at least one passage, and
wherein the valve arrangement further comprises an overload valve which is connected to is the rear hydraulic chamber region by means of at least one overload passage, wherein an overload passage gap enables a transfer flow of hydraulic fluid from the rear hydraulic chamber region into the front hydraulic chamber region when the overload valve is in the open state,
characterized in that
the valve arrangement further comprises an eccentrically arranged multiplier valve, and wherein the rear effective area of the multiplier valve is in operative hydraulic connection with the eccentric hydraulic compartment and the front effective area of the multiplier valve with the front hydraulic chamber region such that hydraulic fluid will flow out of the eccentric hydraulic compartment into the front hydraulic chamber region when the multiplier valve is open, and that
the effective flow cross section of the open multiplier valve is smaller than the effective flow cross section through the overload passage gap of the open overload valve.

2. The device according to claim 1,
wherein a throttle pin fixed to the cylinder extends into the connecting area between the rear hydraulic chamber region, and the transfer-flow area, wherein the throttle pin is formed such that a throttle gap is formed between the throttle pin and the transfer-flow area with its cross section dependent on the depth of penetration of the hollow piston into the cylinder.

3. The device according to claim 1,
wherein the overload valve is pressed into its valve seat by means of a spring, preferably an annular spring.

4. The device according to claim 3,
wherein the minimum force necessary to open the multiplier valve in consequence of the pressure ratio between the pressure in the eccentric hydraulic compartment and the pressure in the front hydraulic chamber region is less than the minimum force necessary to open the overload valve, in particular to force applied by the spring.

5. The device according to claim 1,
wherein the valve arrangement further comprises a non-return valve, in particular a ball valve, wherein said non-return valve is arranged such that it enables a return flow of the hydraulic fluid from the front hydraulic chamber region into the transfer-flow area and/or s into the rear hydraulic chamber region precisely when the pressure in the front hydraulic chamber region is greater than at least one of the pressure values in the transfer-flow area or the rear hydraulic chamber region.

6. The device according to claim 1,
wherein the area ratio between the front effective area of the multiplier valve and the rear effective area of the multiplier valve is selected such that a multiple of the pressure, particularly two to eight times the pressure of the hydraulic fluid in the front hydraulic chamber region needs to prevail in the eccentric hydraulic component to open said multiplier valve.

7. The device according to claim 1,
wherein the actuating force necessary to open the overload valve is predefinable.

8. The device according to claim 1,
wherein the actuating force necessary to open the overload valve can be widely adapted to the requirements of the respective application without considerable constructional modifications.

9. The device according to claim 1,
wherein the head space is filled with a gas under positive pressure relative to the ambient pressure, particularly nitrogen.

10. The device according to claim 1,
wherein the hollow piston comprises at least one hollow piston sealing element, configured such that essentially no hydraulic fluid can reach the outer area of the hollow piston not pushed into the cylinder during the sealing displacement of the hollow piston s within said cylinder.

11. The device according to claim 1,
wherein the separating piston comprises at least one separating piston sealing element which ensures a leveling off of hydraulic fluid during the sealing displacement of the separating piston within the hollow piston such that essentially no hydraulic fluid can reach the head space.

12. The device according to claim 1,
wherein the multiplier valve comprises a multiplier valve damper, wherein the multiplier valve damper comprises the following:
a damping piston connected to the front effective area of the multiplier valve;
a damping annulus between the front effective area and the damping piston; and
a damper overflow mechanism which interacts with the damping piston such that a largely undamped transfer flow of hydraulic fluid occurs between the front hydraulic chamber region and the damping annulus when the multiplier valve is opened to its maximum and a damped transfer flow of hydraulic fluid occurs from the damping annulus into the front hydraulic chamber region when the multiplier valve is moved out of its maximum open position toward its closed position,
wherein the damper overflow mechanism is designed to dampen the velocity of the multiplier valve movement during the damped transfer flow of hydraulic fluid.

13. A method of using the device according to claim 1 as a regenerative energy absorbing element in a track-guided vehicle, in particular a railway vehicle.

14. A track-guided vehicle, in particular a railway vehicle, including a device according to claim 1.
